(19) United States
(12) Patent Application Publication
(10) Pub. No.: US 2009/0195915 A1
(43) Pub. Date: Aug. 6, 2009

(54) METHOD OF FORMING REFERENCE PATTERN

(75) Inventors: Ho-chul SHIN, Suwon-si (KR); Ho-joon CHOI, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/330,615

(22) Filed: Dec. 9, 2008

(30) Foreign Application Priority Data
Feb. 4, 2008 (KR) 2008-11090

(51) Int. Cl. G11B 5/596

(52) U.S. Cl. 360/77.05; G9B/5.216

(57) ABSTRACT

A method of forming a reference pattern. The method includes: determining whether a boundary point of an initial reference pattern is located at an inner diameter region of a disk, which is inside an outermost circumferential track; and if the boundary point of the initial reference pattern is located at the inner diameter region of the disk, additionally forming a compensated reference pattern integrally with the initial reference pattern so that a final reference pattern extends in the direction of an outer diameter of the disk. The method allows compensation for a defective reference pattern into an effective reference pattern by extending the initial reference pattern according to whether the boundary point of the initial reference pattern is located inside the outermost circumferential track of the disk.

### CROSS-REFERENCE TO RELATED APPLICATIONS

This application claims the benefit of Korean Patent Application No. 10-2008-0011090, filed on Feb. 4, 2008, in the Korean Intellectual Property Office, the disclosure of which is incorporated herein in its entirety by reference.

### BACKGROUND

1. Field of the Invention

The present general inventive concept relates to a method of forming a reference pattern, and more particularly, to a method of forming a normal reference pattern in a disk drive containing a defective reference pattern by compensating for the defective reference pattern.

2. Description of the Related Art

Since information is not recorded on a disk during manufacturing, position information that is needed to write or read information to or from a disk must be recorded on the disk by a separate device.

A reference pattern is first created on a disk to write position information for the disk. The process of creating a reference pattern is called servo track writing (STW). During the STW process that occurs at the time of manufacturing, a disk is mounted in a separate servo pattern-forming device to form a reference pattern required for the disk.

A servo track has a servo pattern written thereto that is needed to control the position of a disk. That is, position information including a track number, a pitch between adjacent tracks, and other information needed to follow the center of a track are stored on a servo track.

Once a reference pattern is formed on a disk, the disk is mounted in a hard disk drive (HDD). If the reference pattern has a defect, the defective disk cannot be used properly for reading or writing data. That is, since a process pattern is formed by reading out the reference pattern in the HDD, the process pattern cannot be formed properly using the defective reference pattern.

Thus, to overcome the problem, the defective disk has to be dismounted from the hard disk drive so that the reference pattern can be correctly rewritten to the disk. Alternatively, the defective disk may be disposed and replaced with a new disk (having no defects).

However, it takes a large amount of time and cost to dismount a disk from a HDD and correctly rewrite a reference pattern to the disk. Discarding and replacing the defective disk with a new disk may also cause additional costs.

### SUMMARY

The present general inventive concept provides a method of forming a normal reference pattern in a disk drive containing a defective reference pattern by compensating for the defective reference pattern.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of forming a reference pattern, the method including determining whether a boundary point of an initial reference pattern is located at an inner diameter region of a disk, which is inside an outermost circumferential track; and if the boundary point of the initial reference pattern is located at the inner diameter region of the disk, additionally forming a compensated reference pattern integrally with the initial reference pattern so that a final reference pattern extends in the direction of an outer diameter of the disk.

The method may further include measuring a gap between an outermost circumferential limit and the initial reference pattern before the determining of whether the boundary point of the initial reference pattern is located at the inner diameter region of the disk.

In the determining of whether the boundary point of the initial reference is located at the inner diameter region of the disk, the determination may be performed using the gap between the outermost circumferential limit and the initial reference pattern.

The method may further include terminating a formation of the compensated reference pattern, if the compensated reference pattern extends to the outermost circumferential track.

In the forming of the compensated reference pattern, a read head may read the initial reference pattern and a write head may additionally write the read initial reference pattern beyond the boundary point of the initial reference pattern in the direction towards the outer diameter of the disk.

In the forming of the compensated reference pattern, a point at which the initial reference pattern starts to be read may be determined by a distance between the write head and the read head.

In the forming of the compensated reference pattern, the initial reference pattern may start to be read at a point that is spaced apart from the boundary point of the initial reference pattern to the inner diameter region of the disc by the distance between the write head and the read head.

The forming of the compensated reference pattern may comprise: designating a track adjacent to the boundary point of the initial reference pattern as a specific track number n (n is a natural number); and forming the compensated reference pattern to track number i (i is a natural number decreased from n)

The specific track number n may be determined based on the number of tracks between the boundary point of the initial reference pattern and an outermost circumferential track.

The specific track number n may be set to a value that is greater than the number of tracks between the boundary point of the initial reference pattern and the outermost circumferential track.

In the forming of the compensated reference pattern, the distance between the write head and the read head may be determined using head skew calibration.

In the measuring of the gap between the outermost circumferential limit and the initial reference pattern, the gap may be determined using a FORST technique.

The measuring of the gap may comprise measuring the time to move from the boundary point of the initial reference pattern to a point at which a BEMF (back electromotive force) is generated, as a VCM (voice coil motor) moves from the inner diameter to the outer diameter of the disk at a constant velocity, and measuring the gap between the outermost circumferential limit and the initial reference pattern by using the measured time and the constant velocity at which the VCM moves.

The method may further include creating a process pattern by copying the final reference pattern after the forming of the compensated reference pattern, wherein the final reference pattern may include the initial reference pattern and the compensated reference pattern formed integrally with the initial reference pattern.

The creating of the process pattern may comprise copying the final reference pattern in the direction from the outer diameter to the inner diameter of the disk.

The foregoing and/or other aspects and utilities of the present general inventive concept may be achieved by providing a method of correcting a reference pattern on a disk, the method including determining a boundary point of an initial reference pattern of the disk, and if the boundary point of the initial reference pattern is determined to be shorter than a predetermined location on the disk, forming a compensated reference pattern integrally with the initial reference pattern so that a final reference pattern extends to the predetermined location on the disk.

The determining a boundary point of an initial reference pattern may include driving a VCM from a point at an inner diameter of the disk at a predetermined velocity across the disk to an end of the initial reference pattern, and measuring the time of the driving of the VCM.

### BRIEF DESCRIPTION OF THE DRAWINGS

The above and other features and utilities of the present general inventive concept will become more apparent by describing in detail exemplary embodiments thereof with reference to the attached drawings in which:

FIG. 1A illustrates a reference pattern in a normal disk drive;

FIG. 1B illustrates a reference pattern in a defective disk drive;

FIG. 2 is a diagram explaining formation of a reference pattern according to an embodiment of the present invention;

FIG. 3 is a flowchart of a method of forming the reference pattern shown in FIG. 2;

FIG. 4A is a diagram explaining an outer circumferential limit illustrated in FIG. 3;

FIG. 4B is a diagram explaining operations in the method of FIG. 3;

FIG. 5 is a diagram explaining operations in the method of FIG. 3; and

FIG. 6 is a diagram explaining operations in the method of FIG. 3.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

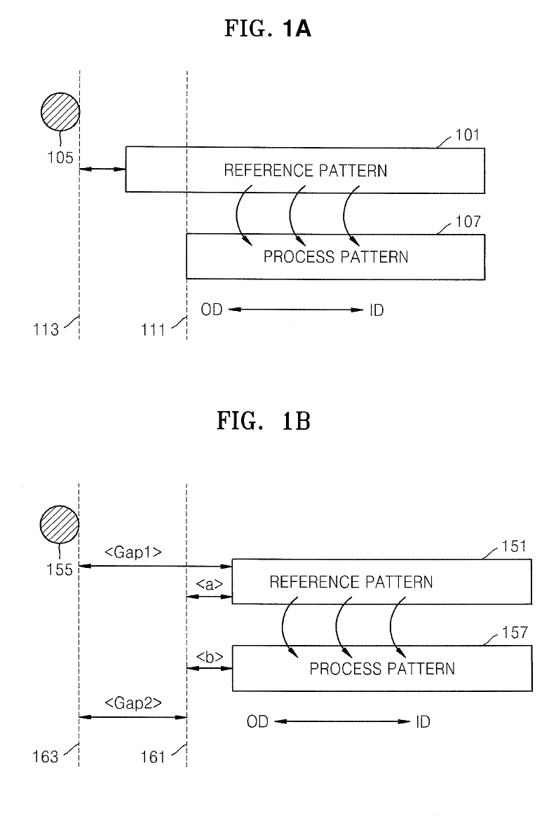

FIG. 1A illustrates a reference pattern 101 in a normal disk drive.

Referring to FIG. 1A, the reference pattern 101 is formed in the normal disk drive. After the reference pattern 101 is formed on a disk at the time of manufacturing the disk, as described above, the disk is mounted in a hard disk drive (HDD) (not shown).

While the left portion of FIGS. 1A and 1B is the direction of an outer diameter (OD) of the disk, the right portion thereof is the direction of an inner diameter (ID) of the disk.

In the HDD, the reference pattern 101 is read out and a process pattern 107 is formed based on the reference pattern 101. To “form” refers to the process of copying and writing the same pattern as the reference pattern 101 to a region on the normal disk drive where the process pattern 107 is formed.

Reference numeral 105 denotes an imaginary point representing an OD crash stop. Thus, a dash line 113 is used to define the OD crash stop at the OD of the disk.

An actuator arm moves a head across the disk. The “OD crash stop” in the disk drive is the farthest point that the head can move in the OD direction. That is, the OD crash stop prevents the head from moving beyond the OD of the disk and defines the outer circumferential limit to how far the head can move away from the disk to write data.

A dash line 111 indicates an end of a region where data tracks are formed. The number of data tracks on each disk typically varies with the specification of a disk drive used. That is, the total number of tracks formed on a disk varies depending on the storage capacity of the HDD.

The location of the dash line 111 varies according to the number of data tracks. The dash line 111 (hereinafter referred to as the “outermost circumferential track 111”) denotes the last track formed along the OD direction.

In the HDD, all tracks from an innermost circumferential track to the outermost circumferential track 111 are used to store data. To write data to all the tracks, the process pattern 107 must extend all the way to the outermost circumferential track 111.

In the normal disk drive shown in FIG. 1, the reference pattern 101 extends beyond the outermost circumferential track 111 in the OD direction. Thus, it is possible to form the process pattern 107 that extends to the outermost circumferential track 111 by reading out the reference pattern 101.

FIG. 1B illustrates a reference pattern 151 in a defective disk drive.

Referring to FIG. 1B, the reference pattern 151 is formed at an ID region of the disk, which is inside an outermost circumferential track 161. Thus, a process pattern 157 is also formed by copying the reference pattern 151 to the ID region of the disk, which is inside the outermost circumferential track 161.

Data cannot be written to tracks in a gap <b> on the disk. The disk drive having the reference pattern 151 shown in FIG. 1B proves to be defective. Referring to FIG. 1B, the reference pattern 151 is shorter than the reference pattern 101 in the normal disk drive which is shown in FIG. 1A. If the reference pattern 151 is defective as shown in FIG. 1B, the defective disk drive must be subjected to re-servo track writing (ReSTW) or be discarded.

A ReSTW process refers to the process of correctly rewriting a reference pattern to a disk drive with a defective reference pattern. A conventional ReSTW process includes dismounting a disk from a HDD, rewriting a reference pattern to the disk, and inserting the disk into the HDD.

The present general inventive concept provides a method of forming a normal reference pattern in a disk drive with a defective reference pattern, as shown in FIG. 1B, by compensating for the defective reference pattern without having to perform a re-servo track writing process.

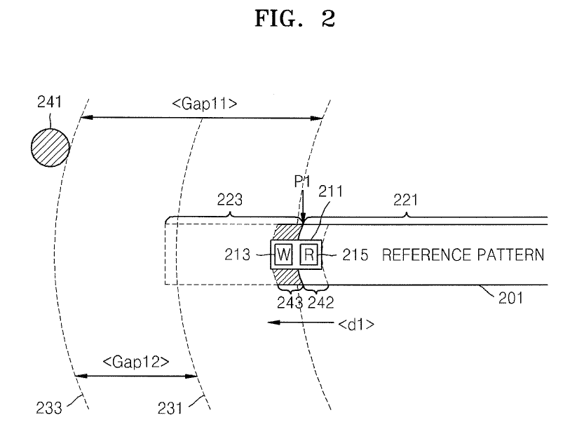

FIG. 2 is a diagram explaining formation of a reference pattern 201 according to an embodiment of the present general inventive concept.

Referring to FIG. 2, the reference pattern 201 according to the present embodiment includes a defective reference pattern 221 and a compensated reference pattern 223 that is additionally formed along an OD of a disk. A process of forming the compensated reference pattern 223 is performed within a HDD. As described above, conventionally, to compensate for a defective reference pattern, a disk has to be dismounted from a HDD and inserted into a ReSTW apparatus. After being subjected to the ReSTW process, the disk is placed back into the HDD for use.

Unlike the conventional method, a method of forming a reference pattern according to the present embodiment allows compensation for a defective reference pattern within a HDD, thereby eliminating the need to dismount the disk from the HDD.

Referring to FIG. 2, P1 denotes a boundary point between the defective reference pattern 221 (corresponding to 157 in FIG. 1B) and the compensated reference pattern 223. That is, the defective reference pattern 221 initially extends to the point P1 at the time of manufacture. A reference pattern (the defective reference pattern 221) written at the time of manufacture and a reference pattern (the compensated reference pattern 223) being additionally written are hereinafter referred to as an “initial reference pattern” and a “compensated reference pattern.” Reference numeral 241 denotes a virtual OD crash stop and a dash line 233 is used to define the outer circumferential limit of how far a head 211 can move away from the disk. Reference numeral 231 indicates an outermost circumferential track. The head 211 includes a write head 213 and a read head 215.

The initial reference pattern 221 additionally extends beyond the point P1 in the OD direction indicated by <d1>. That is, an additional reference pattern is written in the direction <d1>.

The read head 215 reads a portion (e.g., 242) of the initial reference pattern 221 and the write head 213 writes the read portion that extends from the point P1 onto a portion 243 of the compensated reference pattern 223. More specifically, the portion 242 of the initial reference pattern 221 is read out and written to the portion 243 of the compensated reference pattern 223.

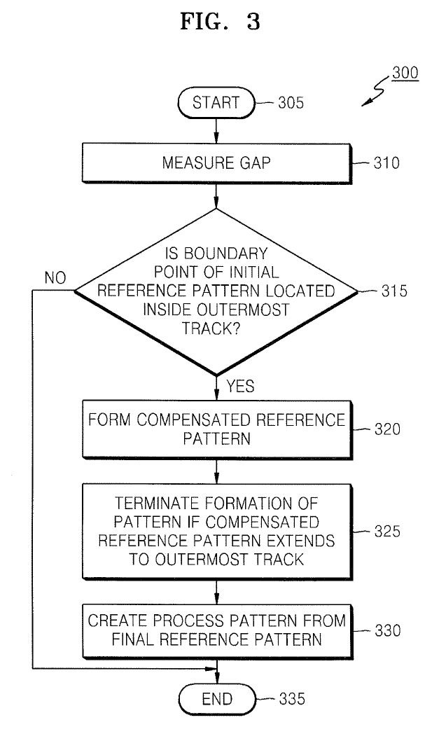

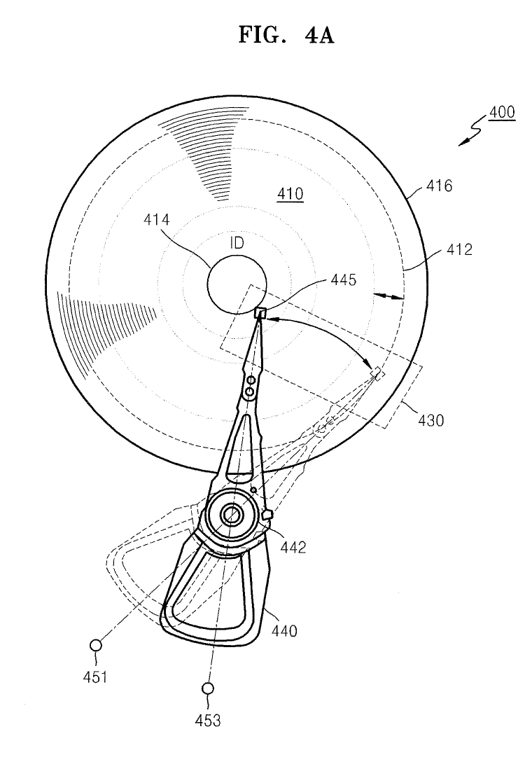

A method of forming a reference pattern according to an embodiment of the present general inventive concept will now be described in detail with reference to FIGS. 3 through 5.

FIG. 3 is a flowchart of a method 300 of forming the reference pattern shown in FIG. 2.

Referring to FIGS. 2 and 3, it is determined whether the boundary point P1 of the initial reference pattern 221 is located at the ID region of the disk, which is inside the outermost circumferential track 231 (operation 315).

Before performing operation 315, the method 300 according to the present embodiment may include measuring a gap <Gap11> between the outer circumferential limit 233 and the initial reference pattern 221 (operation 310). Operation 315 is performed by comparing a gap <Gap12>, between the outer circumferential limit 233 and the outermost circumferential track 231, with the measured gap <Gap11>.

If the boundary point P1 of the initial reference pattern 221 is located outside the outermost circumferential track 231, and thus, not at the ID region of the disk, the method 300 is terminated (operation 335).

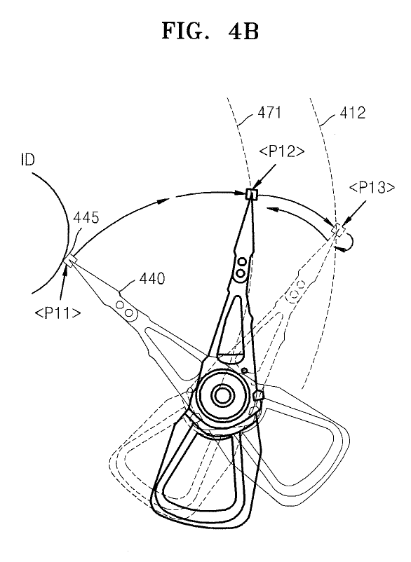

Operations 310 and 315 will be described in more detail later with reference to FIG. 4B.

If the boundary point P1 of the initial reference pattern 221 is located at the ID region of the disk, the compensated reference pattern 223 is formed (operation 320). That is, if the initial reference pattern 221 is so short that a process pattern does not extend to the outermost circumferential track 231, the compensated reference pattern 223 is formed.

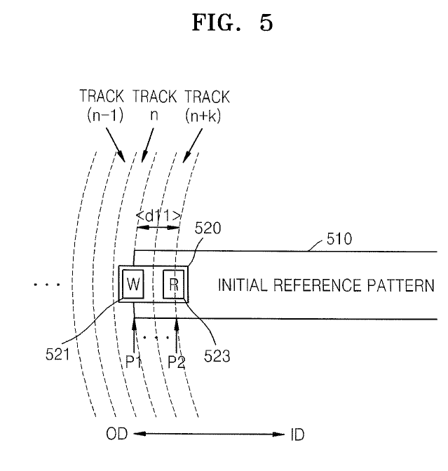

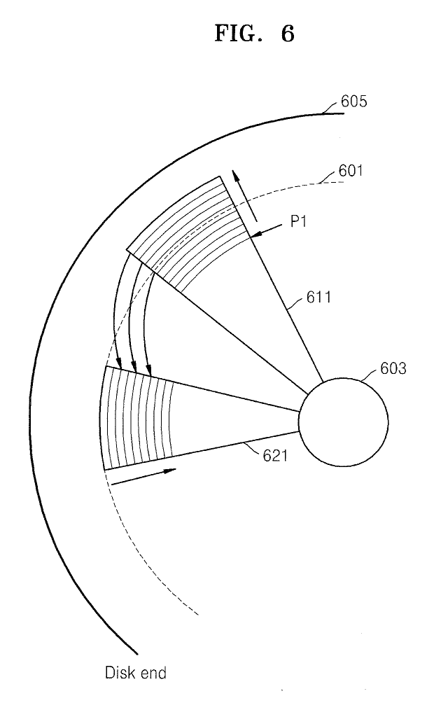

The compensated reference pattern 223 is additionally formed such that the final reference pattern including the initial reference pattern 221 extends toward the OD direction. Operation 320 will be described in more detail later with reference to FIG. 5.

If the compensated reference pattern 223 is determined to extend up to the outermost circumferential track 231, the method 300 may further include terminating the formation of the compensated reference pattern 223 (operation 325).

Upon completion of the formation of the compensated reference pattern 223, the method 300 may further involve forming a process pattern using a final reference pattern (operation 330). The final reference pattern refers to the entire reference pattern 201 including the initial reference pattern 221 and the additional compensated reference pattern 223 being integrally formed with the initial reference pattern 221. Operation 330 will be described in more detail later with reference to FIG. 6.

FIG. 4A is a diagram explaining the outer circumferential limit 233 illustrated in FIG. 3.

FIG. 4A shows an outer circumferential limit 412 necessary to measure the gap <Gap11> in operation 310 in FIG. 3.

In a HDD 400, a voice coil motor (VCM) 442 rotates an actuator arm 440 such that a head 445 mounted to the actuator arm 440 can glide over a disk 410. The actuator arm 440 is driven by a mechanical mechanism to move over the disk 410 that has a predetermined radius between an ID 414 and an OD 416. That is, an OD crash stop 451 and an ID crash stop 453 are respectively provided to prevent the actuator arm 440 from moving past the OD 416 and the ID 414 of the disk 410.

Here, the outer circumferential limit 412 indicates a maximum distance limited by the OD crash stop 451, at which the head 445 can move over the disk 410 in the direction of the OD 416. FIG. 4B is a diagram explaining operations 310 and 315 in the method 300 of FIG. 3. In particular, FIG. 4B shows in detail a portion 430 of the HDD 400 in FIG. 4A.

Referring to FIGS. 4A and 4B, a FORST technique is used to measure a gap between the outer circumferential limit 412 and an initial reference pattern. A FORST technique is used to measure a distance (gap) between specific points on a disk track by sensing a back electromotive force (BEMF) generated at the outer circumferential limit 412 after the VCM 442 is driven to move the head 445 toward the OD direction.

More specifically, the VCM 442 starts to be driven from a point P11 at the ID 414. The VCM 442 rotates at a predetermined velocity such that the head 445 can glide over the disk 410 at a constant velocity. When the head 445 reaches an end 471 of the initial reference pattern, that is a point P12, the time taken for the head 445 to move from the point P11 to the point P12 is measured. By using the velocity and time that the head 445 moves from the point P11 to the point P12, the gap (distance) between the points P11 and P12 can be obtained. The VCM 442 continues to rotate such that the head 445 moves from the point P1 to the point P13 that is on the outer circumferential limit 412 at the constant velocity. Then, the time taken for the head 445 to move from the point P12 to the point P13 is measured.

When the head 445 reaches the outer circumferential limit 412, the OD crash stop 451 prevents the VCM 442 from rotating further in the same direction, thus causing the VCM 442 to rotate in the reverse direction. When the VCM 442 rotates in the reverse direction, the VCM 442 generates a back electromotive force. By sensing the back electromotive force, the position of the outer circumferential limit 412 is detected and the time taken for the head 445 to move from the point P12 to the point P13 that is on the outer circumferential limit 412 is measured. By using the time taken for the head 445 to move between points P12 and P13 and the velocity of the movement of the head 445, the gap (distance) between the points P12 and P13 is obtained.

As described above, the FORST technique is used to measure the distance between two points on different tracks, as the VCM 442 rotates at a constant velocity.

Since a distance between an outer circumferential limit and an outermost circumferential track is already preset according to a storage capacity of the disk, the gap between the outer circumferential limit and initial reference pattern has only to be obtained for comparison in operation 315, as illustrated in FIG. 3.

FIG. 5 is a diagram explaining operation 320 in the method 300 of FIG. 3.

Referring to FIG. 5, a compensated reference pattern starts to be written at the boundary point P1 of an initial reference pattern 510. Track n (n is a natural number) denotes a track adjacent to the boundary point P1. A head 520 includes a write head 521 and a read head 523. K tracks are provided between the write head 521 and the read head 523. That is, a distance <d11> between the write head 521 and the read head 523 is a width of one track multiplied by the k number of tracks.

After the read head 523 reads the initial reference pattern 510, the write head 521 writes the read initial reference pattern 510 so as to form the compensated reference pattern in the OD direction.

A point P1, at which the initial reference pattern 510 starts to be read, is determined by the distance <d11> between the write head 521 and the read head 523. That is, the initial reference pattern starts to be read at the point P2 that is spaced apart from the point P1 by the distance <d11> in the ID direction. Thus, the read head 523 reads the initial reference pattern written to (n+k)-th track (track (n+k)) and then the write head 521 writes the read pattern to n-th track (track n).

While FIG. 5 shows that the first track to which the compensated reference pattern is written is track n, the first track number may be designated by a user. If the first track is numbered n, the compensated reference pattern is written to a track which is numbered i (i is a natural number decreased from n).

The track number n can be determined based on the number of tracks between the boundary point P1 of the initial reference pattern and the outermost circumferential track. That is, by using the gap (distance) obtained by the FORST technique described with reference to FIG. 4B, the number of tracks therebetween can be obtained. It is assumed herein that the width of one track is given.

If about 2,000 tracks are provided between the boundary point P1 of the initial reference pattern and the outermost circumferential track, the number n may be set to 2,000 or more. The number n is also stored in a cylinder of a disk and used as a gray code.

The distance <d11> between the write head 521 and the read head 523 can be obtained using a head skew calibration technique generally known in the art. FIG. 6 is a diagram explaining operation 330 in the method 300 of FIG. 3.

A dash line 601 and a bold solid line 605 denote an outermost circumferential track and an outermost end of a disk, respectively. Reference numeral 603 represents an ID of the disk.

Referring to FIG. 6, a compensated reference pattern is formed outwards from the point P1. After a reference pattern 611 is written, a process pattern 621 is written in a direction from the OD to the ID 603 by copying the reference pattern 611 to a region where the process pattern 621 will be formed.

A method of forming a reference pattern according to an embodiment of present general inventive concept allows compensation for a defective reference pattern into an effective reference pattern by extending an initial reference pattern according to whether the boundary point of the initial reference pattern is located inside the outermost circumferential track of a disk. The methods also allow modification of a defective pattern into an effective reference pattern, thereby preventing discarding of a disk drive while eliminating the need to perform RESTW on the defective reference pattern within a servo copying apparatus.

While this present general inventive concept has been particularly shown and described with reference to preferred embodiments thereof, it will be understood by one skilled in the art that various changes in form and details may be made therein without departing from the spirit and scope of the general inventive concept as defined by the appended claims and their equivalents. The preferred embodiments must be considered in descriptive sense only and not for purposes of limitation.

What is claimed is:

1. A method of forming a reference pattern, the method comprising:
determining whether a boundary point of an initial reference pattern is located at an inner diameter region of a disk, which is inside an outermost circumferential track; and
if the boundary point of the initial reference pattern is determined to be located at the inner diameter region of the disk, forming a compensated reference pattern integrally with the initial reference pattern so that a final reference pattern extends in the direction of an outer diameter of the disk.

2. The method of claim 1, further comprising:
measuring a gap between an outermost circumferential limit and the initial reference pattern before the determining of whether the boundary point of the initial reference pattern is located at the inner diameter region of the disk,.

3. The method of claim 2, wherein in the determining of whether the boundary point of the initial reference is located at the inner diameter region of the disk, the determination is performed using the gap between the outermost circumferential limit and the initial reference pattern.

4. The method of claim 1, further comprising:
terminating a formation of the compensated reference pattern, if the compensated reference pattern extends to the outermost circumferential track.

5. The method of claim 1, wherein in the forming of the compensated reference pattern, a read head reads the initial reference pattern and a write head additionally writes the read initial reference pattern beyond the boundary point of the initial reference pattern in the direction towards the outer diameter of the disk.

6. The method of claim 5, wherein in the forming of the compensated reference pattern, a point at which the initial reference pattern starts to be read is determined by a distance between the write head and the read head.

7. The method of claim 6, wherein in the forming of the compensated reference pattern, the initial reference pattern starts to be read at a point that is spaced apart from the boundary point of the initial reference pattern to the inner diameter region of the disc by the distance between the write head and the read head.

8. The method of claim 7, wherein the forming of the compensated reference pattern comprises:
designating a track adjacent to the boundary point of the initial reference pattern as a specific track number n (n is a natural number); and
forming the compensated reference pattern to track number i (i is a natural number decreased from n)

9. The method of claim 8, wherein the specific track number n is determined based on the number of tracks between the boundary point of the initial reference pattern and an outermost circumferential track.

10. The method of claim 9, wherein the specific track number n is set to a value that is greater than the number of tracks between the boundary point of the initial reference pattern and the outermost circumferential track.

11. The method of claim 8, wherein the specific track number n is a gray code stored in a cylinder of the disk.

12. The method of claim 3, wherein in the forming of the compensated reference pattern, the distance between the write head and the read head is determined using head skew calibration.

13. The method of claim 1, wherein in the measuring of the gap between the outermost circumferential limit and the initial reference pattern, the gap is determined using a FORST technique.

14. The method of claim 13, wherein the measuring of the gap comprises measuring the time to move from the boundary point of the initial reference pattern to a point at which a BEMF (back electromotive force) is generated, as a VCM (voice coil motor) moves from the inner diameter to the outer diameter of the disk at a constant velocity, and measuring the gap between the outermost circumferential limit and the initial reference pattern by using the measured time and the constant velocity at which the VCM moves.

15. The method of claim 1, after the forming of the compensated reference pattern, further comprising creating a process pattern by copying the final reference pattern, wherein the final reference pattern includes the initial reference pattern and the compensated reference pattern formed integrally with the initial reference pattern.

16. The method of claim 15, wherein the creating of the process pattern comprises copying the final reference pattern in the direction from the outer diameter to the inner diameter of the disk.

17. A method of correcting a reference pattern on a disk, the method comprising:
determining a boundary point of an initial reference pattern of the disk; and
if the boundary point of the initial reference pattern is determined to be shorter than a predetermined location on the disk, forming a compensated reference pattern integrally with the initial reference pattern so that a final reference pattern extends to the predetermined location on the disk.

18. The method of claim 17, wherein the determining a boundary point of an initial reference pattern comprises:
driving a VCM from a point at an inner diameter of the disk at a predetermined velocity across the disk to an end of the initial reference pattern; and
measuring the time of the driving of the VCM.
